(19) United States
(12) Patent Application Publication
(10) Pub. No.: US 2009/0119944 A1
(43) Pub. Date: May 14, 2009

(54) Clothing dryer

(75) Inventors: Dong-Geun Lee, Seoul (KR); Soo-Won Park, Seoul (KR)

Correspondence Address: MCKENNA LONG & ALDRIDGE LLP, 1900 K STREET, NW, WASHINGTON, DC, 20006, US

(73) Assignee: LG ELECTRONICS INC., Yeongduengo-Gu (KR)

(21) Appl. No.: 12/285,883

(22) Filed: Oct. 15, 2008

(30) Foreign Application Priority Data
Oct. 15, 2007 (KR) 10-2007-01403714

(51) Int. Cl. F26B 21/10; D06F 58/04

(52) U.S. Cl. 34/524; 34/138

(57) ABSTRACT

Disclosed is a clothing dryer comprising a drum in which a drying object is contained, an exhaust duct connected to the drum and exhausting air in the drum, a blowing fan mounted at an intermediate portion of the exhaust duct and configured to move air, a fan housing receiving the blowing fan and temperature sensors installed at the fan housing. And, temperature sensor mounting portions are formed in the fan housing so as to prevent foreign materials from being accumulated at a front portion of the temperature sensors disposed at a front side of a flow direction of air passing through the fan housing, accordingly it is capable of preventing the foreign materials such as lint from being accumulated at the front side of the temperature sensors and of reducing resistance against air flow.

This application claims the benefit of Korean Patent Application No. 10-2007-0103714 filed Oct. 15, 2007 which is hereby incorporated by reference for all purposes as if fully set forth herein.

### BACKGROUND OF THE INVENTION

1. Field of the Invention

The present invention relates to a clothing dryer, and particularly, to a clothing dryer having a fan housing provided with temperature sensor mounting portions which is capable of preventing foreign materials such as lint from being accumulated at one or more temperature sensors installed at the fan housing for outwardly exhausting hot air blowing in a drum.

2. Background of the Invention

A clothing dryer serves to dry an object to be dried or a drying object by evaporating moisture contained in the drying object resulting from supplying hot air into a drum.

FIG. 1 is a front section view showing a clothing dryer in the related art, and FIG. 2 is a perspective view partially showing a blowing fan and a fan housing applied to the clothing dryer of FIG. 2, and FIG. 3 is a perspective view showing temperature sensors installed at the fan housing and mounting portions for the temperature sensors of FIG. 2.

As shown in FIGS. 1 and 2, the related clothing dryer 1 generally includes a cylindrical drum 11, an air intake duct 17 in which a heater 18 for supplying hot air into the drum 11 and a heater case 19 are installed, an exhaust duct 24 for outwardly exhausting the air in the drum 11 containing much moisture having been evaporated from a drying object and a driving motor 40 for rotating the drum 11.

And, a blowing fan 22 generating a flowing force is installed in the clothing dryer 1 so as to exhaust air through the exhaust duct 24. The blowing fan 22 is simultaneously operated together with the drum 11 by the driving motor 40. One end portion of a driving shaft 29 of the driving motor 40 is directly connected to the blowing fan 22 and another end portion thereof is connected to a belt 28 encompassing the drum 11.

Here, a motor bracket 27 is installed at a lower portion of the driving motor 40 so as to support both end portions of the driving motor 40 in back and forth directions with being fixed at a lower surface of the clothing dryer 1.

An idler 13 is installed at one side of the motor bracket 27 so as to maintain a tension of the belt 28 while the drum 11 is operated.

Meanwhile, the blowing fan 22 is received in a fan housing 23.

The exhaust duct 24 communicated toward the outside of the clothing dryer 1 is connected to a rear side of the fan housing 23 so as to exhaust air blowing from the blowing fan 22 outside of the clothing dryer 1. The exhaust duct 24 is mounted in an exhaust duct connection hole 25 formed at the rear side of the fan housing 23.

As shown in FIG. 3, temperature sensors 31, 32 for sensing a temperature of hot air in the drum 11 by the blowing fan 22 are installed at the fan housing 23. Here, the fan housing 23 is provided with a first temperature sensor insertion hole 23a, a first coupling means insertion hole 23b, a second temperature sensor insertion hole 23c and a second coupling means insertion hole 23d so as to mount the temperature sensors 31, 32.

The temperature sensors 31, 32 are respectively inserted into the first temperature sensor insertion hole 23a and the second temperature sensor insertion hole 23c so as to sense a temperature of blowing air. And, coupling means such as a screw for fixing the temperature sensors 31, 32 at the fan housing 23 are mounted in the first coupling means insertion hole 23b and the second coupling means insertion hole 23d. Here, the first and second coupling means insertion holes 23b, 23d are disposed at a front side of the first and second temperature sensor insertion holes 23a, 23c with respect to a flow direction (F) of air passing through the fan housing 23.

However, the coupling means such as the screw inserted into the first and second coupling means insertion holes 23b, 23d formed at an upper side based on the flow direction (F) of air with respect to the first and second temperature sensor insertion holes 23a, 23c may be protruded into the fan housing 23 and then foreign materials such as lint contained in the air passing through the fan housing 23 may be caught on the protruded coupling means, which causes resistance against air flow.

And, performance of the temperature sensors 31, 32 may be deteriorated due to the foreign materials such as lint caught to be accumulated on the coupling means mounted in a front side of the temperature sensors 31, 32. That is, air cannot directly reach the temperature sensors 31, 32 due to the foreign materials, accordingly it may be difficult to precisely sense the temperature.

Furthermore, since there are many coupling means insertion holes for fixing the temperature sensors 31, 32 at the fan housing 23, it takes lots of time to assemble the temperature sensors.

### SUMMARY OF THE INVENTION

Therefore, an object of the present invention is to provide a clothing dryer having a fan housing provided with temperature sensor mounting portions which is capable of preventing foreign materials such as lint from being caught or accumulated at a front side of temperature sensors.

Another object of the present invention is to provide a clothing dryer which is capable of preventing performance of temperature sensors installed at a fan housing from being deteriorated.

Still another object of the present invention is to provide a clothing dryer which is capable of enhancing productivity and of reducing a fabrication cost because an assembly process for mounting temperature sensors at a fan housing is simple.

To achieve these and other advantages and in accordance with the purpose of the present invention, as embodied and broadly described herein, there is provided a clothing dryer comprising, a drum in which a drying object is contained, an exhaust duct connected to the drum and exhausting air in the drum, a blowing fan mounted at an intermediate portion of the exhaust duct and configured to move air, a fan housing receiving the blowing fan, a temperature sensor installed at the fan housing and a temperature sensor mounting portion formed at the fan housing so as to prevent foreign materials from being accumulated at a front portion of the temperature sensor disposed at a front side of a flow direction of air passing through the fan housing. Here, the temperature sensor is a first temperature sensor disposed at the front side of the flow direction of air, and the temperature sensor mounting portion is a first temperature sensor mounting portion at which the first temperature sensor is mounted.

Accordingly, it is capable of preventing foreign materials such as lint from being accumulated at the front side of the temperature sensor and of preventing performance of the temperature sensor from being deteriorated.

And, the clothing dryer may further comprise a second temperature sensor disposed at a rear side of the first temperature sensor and a second temperature sensor mounting portion at which is the second temperature sensor is mounted. Accordingly, it is capable of more precisely sensing a temperature by diversifying the kind of the first temperature sensor and the second temperature sensor. That is, one of the temperature sensors may be implemented as a mechanical temperature sensor and the other may be implemented as an electronic temperature sensor. Here, the number of the temperature sensors is not limited to the first temperature sensor and the second temperature sensor.

Meanwhile, at least one of the first temperature sensor mounting portion and the second temperature sensor mounting portion comprises a temperature sensor insertion hole formed at the front side of the flow direction of air passing through the fan housing and a temperature sensor coupling means insertion hole formed at the rear side of the temperature sensor insertion hole in the flow direction of air. As such, by additionally disposing the temperature sensor coupling means insertion hole, it is capable of enhancing a coupling force between the temperature sensors and the fan housing.

Here, the second temperature sensor mounting portion may further comprise a temperature sensor pseudo-assembly unit formed at the front side of the temperature sensor insertion hole. Accordingly, it is capable of easily assembling the second temperature sensor. And, as an additional coupling means is not mounted at the temperature sensor pseudo-assembly unit, it is capable of reducing a fabrication cost.

It is effective that the temperature sensor pseudo-assembly unit is formed by an intaglio manner and comprises an insertion portion protruded toward a rear surface of the fan housing and a locking portion integrated with the fan housing. Accordingly, it is capable of preventing an additional coupling means from being protrudingly formed at the front side of the second temperature sensor insertion hole and of preventing one portion of the second temperature sensor from being exposed to an inside of the fan housing.

And, one of the first temperature sensor and the second temperature sensor is implemented as a thermistor and the other is implemented as a thermostat, preferably.

Meanwhile, to achieve these objects of the present invention, in accordance with a second embodiment of the present invention, there is provided a clothing dryer comprising, a drum in which a drying object is contained, an exhaust duct connected to the drum and exhausting air in the drum, a blowing fan mounted at an intermediate portion of the exhaust duct and configured to move air, a fan housing receiving the blowing fan, a temperature sensor installed at the fan housing, a temperature sensor insertion hole formed in the fan housing so as to prevent foreign materials from being accumulated at a front portion of the temperature sensor and fixing means formed at the temperature sensor so as to fix the temperature sensor by passing through the temperature sensor insertion hole.

With such configuration, it is capable of preventing foreign materials such as lint from being accumulated at the front portion of the temperature sensor, of preventing performance of the temperature sensor from being deteriorated and of easily mounting the temperature sensor at the fan housing.

Here, the fixing means are implemented as locking hooks having an elastic characteristic, preferably.

And, the temperature sensor further comprises a stopping flange spaced from the locking hooks so as to prevent a phenomenon that the temperature sensor completely passes through the temperature sensor insertion hole of the fan housing and thus it is not fixed.

Preferably, the locking hooks are formed to be inclined in an insertion direction of the temperature sensor. That is, as the fixing means are inclinedly formed with implementing a distance therebetween to be closer in the insertion direction for the temperature sensor, it is capable of easily mounting the temperature sensor and of maximally utilizing an elastic resilience force of the locking hooks. Here, the temperature sensor is implemented as a thermostat, preferably.

Meanwhile, to achieve these objects of the present invention, in accordance with a third embodiment of the present invention, there is provided a clothing dryer comprising, a drum in which a drying object is contained, an exhaust duct connected to the drum and exhausting air in the drum, a blowing fan mounted at an intermediate portion of the exhaust duct and configured to move air, a fan housing receiving the blowing fan, a first temperature sensor installed at the fan housing and a second temperature sensor installed at a rear side of the first temperature sensor. Here, the fan housing is provided with first temperature sensor mounting portions formed to be parallel with a flow direction of air passing through the fan housing and second temperature sensor mounting portions disposed at a rear side of the first temperature sensor mounting portions and formed to be perpendicular to the flow direction of air.

Here, the first temperature sensor mounting portions comprise a temperature sensor insertion hole into which the first temperature sensor is inserted and a temperature sensor coupling means insertion hole formed at the rear side of the temperature sensor insertion hole so as to be parallel with the flow direction of air. And, the second temperature sensor mounting portions comprise a temperature sensor insertion hole into which the second temperature sensor is inserted and temperature sensor coupling means insertion holes formed at both sides of the temperature sensor insertion hole so as to be perpendicular to the flow direction of air.

With such configuration, it is capable of preventing foreign materials such as lint from being accumulated at the front side of the first and second temperature sensors.

Preferably, one of the first temperature sensor and the second temperature sensor is implemented as a thermistor and the other is implemented as a thermostat, and the fan housing is formed of steel.

As aforementioned, according to the present invention, the temperature sensor coupling means insertion hole is not formed at the front side of the temperature sensor insertion hole at which the temperature sensor is mounted, accordingly it is capable of preventing foreign materials such as lint from being accumulated at the front side of the temperature sensor and of reducing resistance against air flow.

And, according to the present invention, the foreign materials such as lint are induced to be accumulated at the rear side of the temperature sensor, not the front side thereof, accordingly it is capable of preventing performance of the temperature sensor from being deteriorated.

Further, according to the present invention, an assembly process for mounting the temperature sensor in the fan housing is simplified, accordingly it is capable of enhancing productivity. And, the number of needed coupling means is reduced, accordingly it is capable of reducing a fabrication cost.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a front section view showing a clothing dryer in the related art;

FIG. 2 is a perspective view partially showing a blowing fan and a fan housing adapted to the clothing dryer in FIG. 1;

FIG. 3 is a perspective view showing temperature sensors in the fan housing and their mounting portions of FIG. 2;

FIG. 4 is a perspective view showing temperature sensor mounting portions formed at a fan housing in accordance with a first exemplary embodiment of the present invention;

FIG. 5 is a perspective view showing that temperature sensors are mounted in the temperature sensor mounting portions of FIG. 4;

FIG. 6 is a perspective view showing an outer surface of the fan housing of FIG. 5;

FIG. 7 is a section view showing that a temperature sensor is mounted at a fan housing in accordance with a second exemplary embodiment of the present invention; and

FIG. 8 is a perspective view showing temperature sensor mounting portions formed at a fan housing in accordance with a third exemplary embodiment of the present invention.

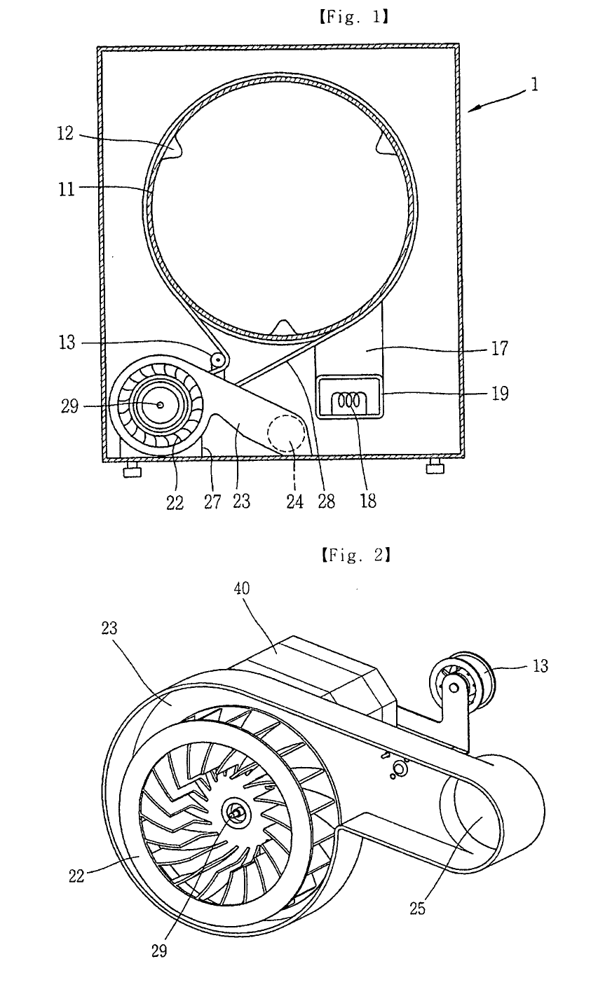

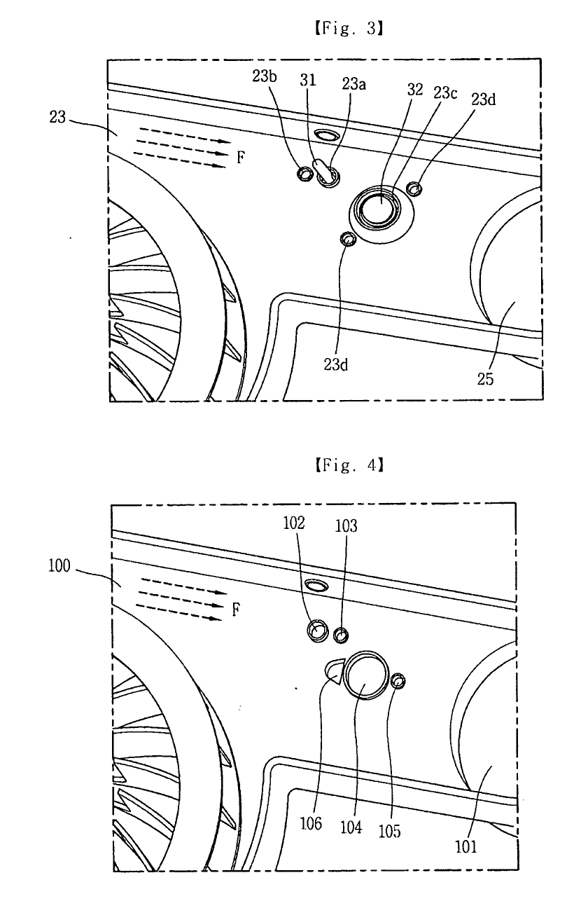

### DETAILED DESCRIPTION OF THE INVENTION

Description will now be given in detail of the present invention, with reference to the accompanying drawings. The same reference numerals are provided to the same parts of this preferred embodiment as those of other preferred embodiments, and thus their detailed explanation will be omitted.

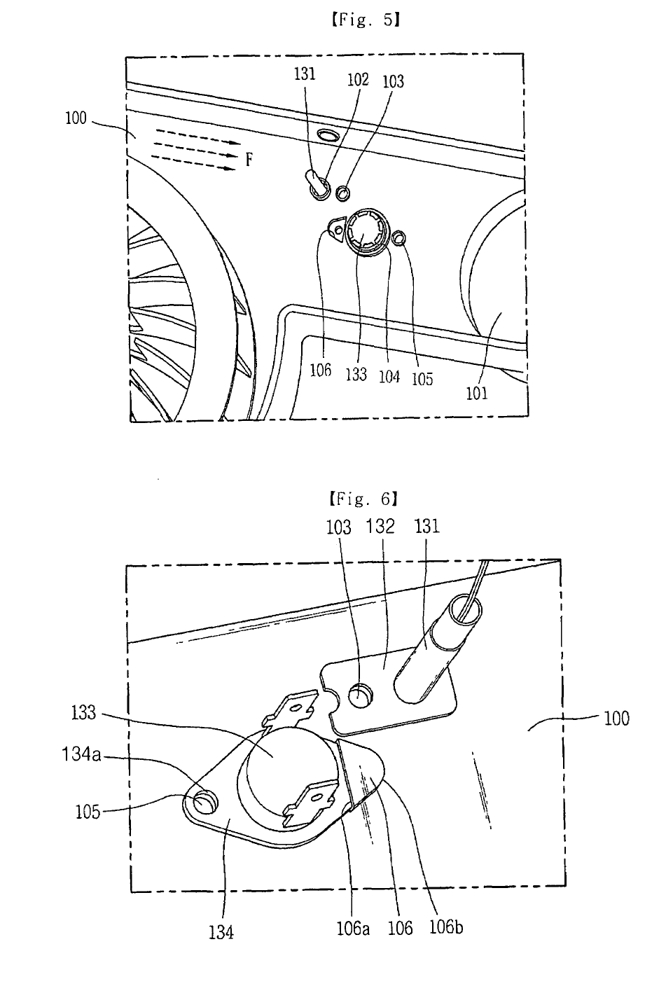

FIG. 4 is a perspective view showing temperature sensor mounting portions formed in a fan housing in accordance with a first exemplary embodiment of the present invention, FIG. 5 is a perspective view showing that temperature sensors are mounted at the temperature sensor mounting portions of FIG. 4, and FIG. 6 is a perspective view showing an outer surface of the fan housing of FIG. 5.

As shown in FIGS. 4 and 5, a clothing dryer 1 in accordance with the first embodiment of the present invention includes a drum 11 in which a drying object is contained, an exhaust duct 24 connected to the drum 11 and exhausting air in the drum 11, a blowing fan 22 mounted at an intermediate portion of the exhaust duct 24 and configured to move air, a fan housing 100 receiving the blowing fan 22, temperature sensors 131, 133 installed at the fan housing 100 and temperature sensor mounting portions formed in the fan housing 100 so as to prevent foreign materials from being accumulated at a front portion of the temperature sensors 131, 133 disposed at a front side of a flow direction (F) of air passing through the fan housing 100.

With such configuration, it is capable of preventing foreign materials such as lint from being accumulated at the front side of the temperature sensors 131, 133 and of preventing performance of the temperature sensors 131, 133 from being deteriorated.

The temperature sensors 131, 133 may include a first temperature sensor 131 installed at the front side of the flow direction (F) of air, that is, at an upper side based on air flow and a second temperature sensor 133 installed at a rear side of the first temperature sensor 131, that is, at a lower side based on air flow.

Here, the number of the temperature sensor installed at the fan housing 100 is not limited to the first and second temperature sensors 131, 133. The kind of the temperature sensor can be various.

That is, when the first temperature sensor 131 and the second temperature sensor 133 are implemented in different types from each other, it is capable of more precisely sensing temperature. For example, one of the temperature sensors 131, 133 may be implemented as a mechanical temperature sensor and the other may be implemented as an electronic temperature sensor.

Here, the kinds of the temperature sensors 131, 133 are merely exemplary. Various kinds of temperature sensors can be adapted and the number of the temperature sensors can be variously adapted.

To simplify an inner configuration of the fan housing 100 in which the temperature sensors 131, 133 are mounted, only one of the temperature sensor 131, 133 can be installed. To enhance accuracy or to provide for a case that one of the temperature sensors is out of order, at least two temperature sensors may be installed.

Here, the temperature sensor mounting portions include first temperature sensor mounting portions 102, 103 at which the first temperature sensor is mounted and second temperature sensor mounting portions 104, 105 at which the second temperature sensor 133 is mounted.

The first temperature sensor mounting portions 102, 103 include a temperature sensor insertion hole 102 formed at the front side of the flow direction (F) of air passing through the fan housing 100 and a temperature sensor coupling means insertion hole 103 formed at the rear side of the flow direction (F) of air in the flow direction (F) of air. The second temperature sensor mounting portions 104, 105 include a temperature sensor insertion hole 104 formed at the front side of the flow direction (F) of air passing through the fan housing 100 and a temperature sensor coupling means insertion hole 105 formed at the rear side of the flow direction (F) of air.

That is, the first temperature sensor mounting portions 102, 103 include a first temperature sensor insertion hole 102 formed at the fan housing 100 so that the first temperature sensor 131 can be mounted inside the fan housing 100 in an exposed state and a first coupling means insertion hole 103 formed at the lower side of the first temperature sensor insertion hole 102 with respect to the air flow direction (F) and configured to mount a coupling means such as a screw for fixing the first temperature sensor 131 at the fan housing 100.

And, the second temperature sensor mounting portions 104, 105 include a second temperature sensor insertion hole 104 formed at the fan housing 100 so that the second temperature sensor 133 can be mounted inside the fan housing in the exposed state and a second coupling means insertion hole 105 formed at the lower side of the second temperature sensor insertion hole 104 with respect to the air flow direction (F) and configured to mount the coupling means such as the screw for fixing the second temperature sensor 133 at the fan housing 100.

As such, by additionally forming the first and second temperature sensor coupling means insertion holes 103, 105 in addition to the first and second temperature sensor insertion holes 102, 104, it is capable of enhancing a coupling force between the temperature sensors 131, 133 and the fan housing 100.

Here, the first temperature sensor mounting portions 102, 103 and the second temperature sensor mounting portions 104, 105 are disposed at positions allowing to sense the temperature of air before the air passing through the fan housing 100 flows out the fan housing 100 through an exhaust duct connection hole 101. That is, by installing the first and second temperature sensors 131, 133 at portions having a narrow width in a channel through which air passes, it is capable of increasing the amount of air contacting the temperature sensors 131, 133.

Since the first and second temperature sensor mounting portions 102, 103, 104, 105 are formed in a burring manner, they are protruded toward the inside of the fan housing 100 by a specific height.

The second temperature sensor mounting portions 104, 105 may further include a temperature sensor pseudo-assembly unit 106 formed at the front side of the second temperature sensor insertion hole 104. Here, the temperature sensor pseudo-assembly unit 106 may be formed by an intaglio manner with respect to an inner surface of the fan housing 100 by punching the inner surface of the fan housing 100, preferably.

Referring to FIG. 6, the temperature sensor pseudo-assembly unit 106 includes an insertion portion 106a protruded toward the outside of the fan housing 100 and a locking (or, stopping) portion 106b integrated with the fan housing 100. That is, the insertion portion 106a of the temperature sensor pseudo-assembly unit 106 is formed by cutting the fan housing 100 by a specific length and pressing the cut portion toward the outside of the fan housing 100 so as to generate a specific gap at the cut portion. And, the locking portion 106b is formed at a position facing the insertion portion 106a with being integrally connected to the fan housing 100.

Here, it is effective that the temperature sensor pseudo-assembly unit 106 is formed in a shape allowing a portion of a body 134 of the second temperature sensor 133 to be inserted thereinto. The body 134 of the second temperature sensor 133 is provided with a coupling opening 134a for mounting a coupling means at the second temperature sensor 133.

A process for mounting the second temperature sensor 133 at the fan housing 100 will be explained.

First, one portion of the body 134 of the second temperature sensor 133 is inserted into the temperature sensor pseudo-assembly unit 106. Here, the one portion of the second temperature sensor body 134 is inserted through the insertion portion 106a of the temperature sensor pseudo-assembly unit 106 until the body 134 cannot be inserted any more by the locking portion 106b of the temperature sensor pseudo-assembly unit 106.

Then, the second temperature sensor 133 is inserted into the second temperature sensor insertion hole 104. In this state, the coupling opening 134a of the second temperature sensor body 134 is communicated with the second temperature sensor coupling means insertion hole 105, and the second temperature sensor body 134 is fixed at the fan housing 100 by inserting the coupling means such as the screw into the coupling opening 134a. Here, an additional coupling means is not mounted at the temperature sensor pseudo-assembly unit 106.

As such, since the coupling means such as the screw is protruded toward the inside of the fan housing 100 only at the rear side of the second temperature sensor 133 with respect to the flow direction (F) of air under a state that the second temperature sensor 133 is completely mounted, it is capable of preventing an additional coupling means from being protrudingly mounted at the front side of the second temperature sensor insertion hole 104 and of preventing foreign materials such as lint from being accumulated at the front side of the second temperature sensor 133.

Further, by providing the temperature sensor pseudo-assembly unit 106, it is easy for the second temperature sensor 133 to find the second temperature sensor insertion hole 104 at the time of mounting the second temperature sensor 133, accordingly it is easy to assemble the second temperature sensor 133. And, since it is not required to additionally mount a coupling means at the temperature sensor pseudo-assembly unit 106, it is capable of reducing a fabrication cost.

Meanwhile, since the first temperature sensor 131 is larger than the second temperature sensor 133, it is not required to additionally have a pseudo-assembly unit. A body 132 of the first temperature sensor 131 is also provided with a coupling opening 132a communicated with the first coupling means insertion hole 103. Accordingly, an additional coupling means is not provided at the front side of the first temperature sensor 131 with respect to the flow direction (F) of air.

Here, one of the first temperature sensor 131 and the second temperature sensor 133 is implemented as a thermistor and the other is implemented as a thermostat, preferably.

Hereafter, a fan housing having a temperature sensor mounting portion in accordance with a second embodiment of the present invention will be explained. FIG. 7 is a section view showing that a temperature sensor is mounted at a fan housing in accordance with the second embodiment of the present invention.

The clothing dryer 1 in accordance with the second embodiment of the present invention includes the exhaust duct 24 connected to the drum 11 and exhausting air in the drum 11, a blowing fan 22 mounted at an intermediate portion of the exhaust duct 24 and configured to move air, a fan housing 200 receiving the blowing fan 22, a temperature sensor 231 installed at the fan housing 200, a temperature sensor insertion hole 204 formed in the fan housing 200 so as to prevent foreign materials from being accumulated at a front portion of the temperature sensor 231 and fixing means 232 configured to fix the temperature sensor 231 by passing through the temperature sensor insertion hole 204.

Here, unlike the first embodiment of the present invention, there is no an additional temperature sensor coupling means insertion hole at a periphery of the temperature sensor insertion hole 204. That is, in the second embodiment, the temperature sensor fixing means 232 formed at the temperature sensor 231 are used to fix the temperature sensor 231 at the fan housing 200 instead of the additional coupling means.

As shown in FIG. 7, the temperature sensor fixing means 232 are formed at a body of the temperature sensor 231. The temperature sensor fixing means 232 are formed along a circumstance of the body of the temperature sensor 231 at least two in number, preferably.

Here, it is effective that the fixing means 232 are implemented as locking hooks having an elastic characteristic. The fixing means 232, as the locking hooks, are formed to be inclined in a direction (D) that the temperature sensor 231 is inserted into the temperature sensor insertion hole 204. That is, as the fixing means 232 are inclinedly formed with implementing a distance therebetween to be closer in the insertion direction (D) for the temperature sensor 231, it is capable of easily mounting the temperature sensor 231 and of maximally utilizing an elastic resilience force of the locking hooks.

Meanwhile, preferably, the temperature sensor 231 is further provided with a stopping flange 233 spaced from the fixing means 232, i.e., locking hooks, so as to prevent a phenomenon that the temperature sensor 231 completely passes through the temperature sensor insertion hole 204 of the fan housing 200 and thus it is not fixed.

Alternately, a screw thread may be respectively formed at the circumference of the body of the temperature sensor 231 and at an inner surface of the insertion hole 204 so as to couple the temperature sensor 231 and the temperature sensor insertion hole 204 to each other. And, the fixing means 232 are not implemented only as the locking hooks.

A gap between the fixing means 232 and the stopping flange 233 may be configured to be same as a thickness of the fan housing 200 so as to fix the temperature sensor 231. Or, an external diameter of the fixing means 232 may be configured to be slightly larger than the temperature sensor insertion hole 204 so as to mount the temperature sensor 231 in a pressing manner. The method for mounting the temperature sensor 231 is not limited thereto.

Here, preferably, the temperature sensor 231 is implemented as the thermostat. Since the thermostat is slightly larger than other temperature sensors, it may not be difficult to form the fixing means at the outside of the temperature sensor.

With such configuration, it is capable of preventing an obstacle from being protruded at the front portion of the temperature sensor 231 inserted into the inside (IS) of the fan housing 200 from the outside (OS) thereof, of preventing foreign materials such as lint from being accumulated at the front portion of the temperature sensor 231, of preventing performance of the temperature sensor 231 from being deteriorated and of easily mounting the temperature sensor 231 at the fan housing 200.

Meanwhile, a height of the fixing means 232 is lower than that of the temperature sensor 231 exposed to the inside (IS) of the fan housing 200, preferably. Because, if the height of the fixing means 232 is too high, the temperature sensor 231 may not come into contact with air.

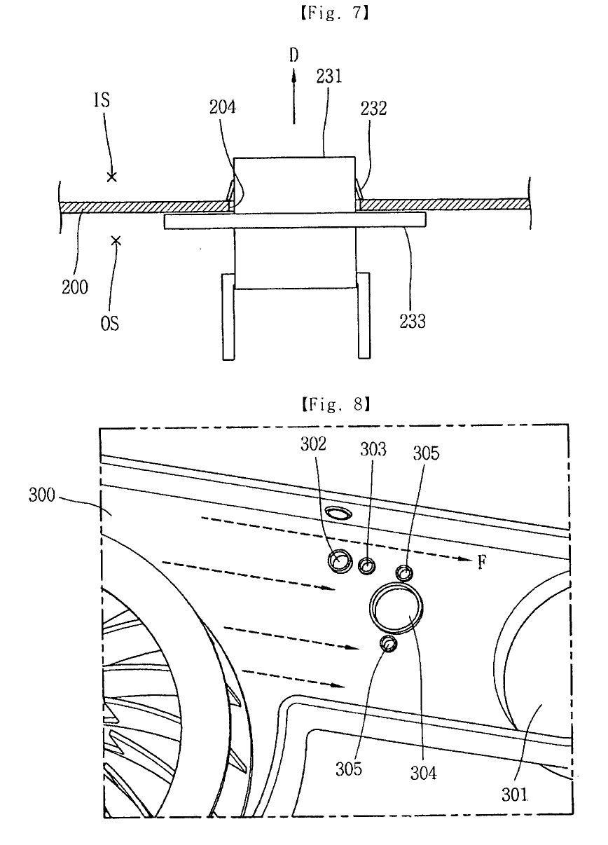

Hereafter, a fan housing having temperature sensor mounting portions in accordance with a third embodiment of the present invention will be explained. FIG. 8 is a perspective view showing the temperature sensor mounting portions formed in the fan housing in accordance with the third embodiment of the present invention.

Referring to FIG. 8, first temperature sensor mounting portions 302, 303 include a temperature sensor insertion hole 302 into which the first temperature sensor 131 (see FIG. 5) is inserted and a temperature sensor coupling means insertion hole 303 formed at the rear side of the temperature sensor insertion hole 302 with respect to the flow direction of air. And, second temperature sensor mounting portions 304, 305 include a temperature sensor insertion hole 304 into which the second temperature sensor 133 (see FIG. 5) is inserted and temperature sensor coupling means insertion holes 305 formed at both sides of the temperature sensor insertion hole 304. The temperature sensor insertion hole 304 and the temperature sensor coupling means insertion holes 305 are formed in a vertical direction with respect to the flow direction of air.

As the temperature sensor insertion holes 303, 305 for mounting the temperature sensor coupling means protruded toward the inside of the fan housing 300 are configured to be formed at other portions excluding the front portion of the temperature sensor with respect to the flow direction (F) of air, it is capable of preventing foreign materials such as line from being accumulated at the front side of the first and second temperature sensors 131, 133. Meanwhile, one of the first temperature sensor 131 and the second temperature sensor 133 is implemented as the thermistor and the other is implemented as the thermostat, preferably. And, the fan housing 300 is formed of steel, preferably.

The clothing dryer having the fan housing provided with the temperature sensor mounting portions may be applied to both exhausting type dryers and condensing type dryers.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothing dryer comprising:
a drum in which a drying object is contained;
an exhaust duct connected to the drum and exhausting air in the drum;
a blowing fan mounted at an intermediate portion of the exhaust duct and configured to move air;
a fan housing receiving the blowing fan;
temperature sensor insertion holes formed at the fan housing; and
temperature sensor coupling means insertion holes formed at a rear side of the temperature sensor insertion holes with respect to air flow passing through the fan housing.

2. The clothing dryer of claim 1, wherein the temperature sensor insertion holes and the temperature sensor coupling means insertion holes are respectively implemented in plural in number.

3. The clothing dryer of claim 1, wherein a temperature sensor pseudo-assembly unit is further formed at a front side of the temperature sensor insertion hole.

4. The clothing dryer of claim 3, wherein the temperature sensor pseudo-assembly unit is formed by an intaglio manner.

5. The clothing dryer of claim 3, wherein the temperature sensor pseudo-assembly unit comprises an insertion portion outwardly protruded from the fan housing and a locking portion integrated with the fan housing.

6. The clothing dryer of claim 2, wherein the plurality of temperature sensors are implemented as a thermistor or a thermostat.

7. A clothing dryer comprising:
a drum in which a drying object is contained;
an exhaust duct connected to the drum and exhausting air in the drum;
a blowing fan mounted at an intermediate portion of the exhaust duct and configured to move air;
a fan housing receiving the blowing fan;
a temperature sensor installed in the fan housing;
a temperature sensor insertion hole formed in the fan housing; and
fixing means formed at the temperature sensor so as to fix the temperature sensor by passing through the temperature sensor insertion hole.

8. The clothing dryer of claim 7, wherein the fixing means are implemented as locking hooks having an elastic characteristic.

9. The clothing dryer of claim 8, wherein the temperature sensor further comprises a stopping flange spaced from the locking hooks.

10. The clothing dryer of claim 8, wherein the locking hooks are formed to be inclined in an insertion direction of the temperature sensor.

11. A clothing dryer comprising:
a drum in which a drying object is contained;
an exhaust duct connected to the drum and exhausting air in the drum;
a blowing fan mounted at an intermediate portion of the exhaust duct and configured to move air;
a fan housing receiving the blowing fan; and
a first temperature sensor and a second temperature sensor installed at the fan housing,
wherein the fan housing is provided with first temperature sensor mounting portions formed to be parallel with a flow direction of air passing through the fan housing and second temperature sensor mounting portions disposed at a rear side of the first temperature sensor mounting portions and formed to be intersected with the flow direction of air.

12. The clothing dryer of claim 11, wherein the first temperature sensor mounting portions comprise a temperature sensor insertion hole into which the first temperature sensor is inserted and a temperature sensor coupling means insertion hole formed at the rear side of the temperature sensor insertion hole so as to be parallel with the flow direction of air.

13. The clothing dryer of claim 11, wherein the second temperature sensor mounting portions comprise a temperature sensor insertion hole into which the second temperature sensor is inserted and temperature sensor coupling means insertion holes formed at both sides of the temperature sensor insertion hole so as to be perpendicular to the flow direction of air.

14. The clothing dryer of claim 11, wherein one of the first temperature sensor and the second temperature sensor is implemented as a thermistor and the other is implemented as a thermostat.

15. The clothing dryer of claim 11, wherein the fan housing is formed of steel.
